(19) United States
(12) Patent Application Publication
(10) Pub. No.: US 2003/0123728 A1
(43) Pub. Date: Jul. 3, 2003

(54) Interactive video installation and method thereof

(75) Inventors: Nevenka Dimitrova, Yorktown Heights, NY (US); Jacquelyn Annette Martino, Cold Spring, NY (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/034,738

(22) Filed: Dec. 28, 2001

(51) Int. Cl. G06K 9/34

(52) U.S. Cl. 382/173; 382/165; 382/282

(57) ABSTRACT

An interactive imaging system and method thereof are provided. The invention provides a real-time interactive video system. The input signals to the system are given through an array of cameras, sensors and microphones. The input signals are generated by human (or pet) presence and involvement. A set of software modules is invoked based on a “rule” framework created by the user, e.g., artist or designer, of the interactive system. The “rules” define which set of input signals are connected to certain portions, i.e., impressible regions, of an image on a display of the system or connected to certain portions on a mosaiced display. The inventive system allows the user to build a set of “rules” as to how the impressible regions of the displayed images can change based on motion, color, and/or texture of a “visitor” interacting with the system.

### BACKGROUND OF THE INVENTION

1. Field of the Invention

The present invention relates generally to image acquisition and processing, and more particularly, to an interactive video installation and method thereof.

2. Background of the Invention

The increasing capacity of digital systems to model, emulate, process or synthesize rich, complex human behaviors has led to the development of human-machine interactive systems or virtual reality systems. These systems have played a large role in the rapid growth of the video gaming industry. One area that interactive systems have not had a significant role is in the arts, both musical and visual.

In 1985, Tod Machover of MIT's Media Lab began to merge computer technology into the musical arts with the development of hyperinstruments, i.e., computer-enhanced musical instruments. An example of such a hyperinstrument is the “Sensor Chair” as shown in FIG. 1, which uses an invisible electric field to detect body motion and turn it into sound. A person seated in the chair 10 becomes an extension of a transmitting antenna plate 12 placed in the chair's cushion and their body acts as a conductor which is capacitively coupled into the transmitter plate 12. Four receiving antennas 16 are mounted at the vertices of a square, on poles placed in front of the chair. These antenna pickups 16 receive the transmitted signal with a strength that is determined by the capacitance between the performer's body and the antenna plate 12. As the seated performer moves his hand forward, the intensities of these signals are thus a function of the distances between the hand and corresponding pickups 16. The pickup signal strengths are digitized and sent to a computer, which estimates the hand position. A pair of pickup antennas 18 are also mounted on the floor of the chair platform, and are used to similarly measure the proximity of left and right feet, providing a set of pedal controllers. Therefore, all movements of the arms, upper body and feet are measured very accurately, and turned into different kinds of music depending on the state of the software residing in the computer coupled to the chair.

In order for a performer to use these sensors 16,18, he must be seated in the chair, and thus coupled to the transmitting antenna. Other performers may also inject signals into the pickup antennas if they are touching the skin of the seated individual, thus becoming part of the extended antenna system. The sensors are used to trigger and shape sonic events in several different ways, depending on the portion of the composition that is being performed. The simplest modes use the proximity of the performer's hand to the hand sensors 16 along the z-axis to trigger a sound and adjust its volume, while using the position of the hand in the sensor plane (x,y) to change the timbral characteristics. Other modes divide the x,y plane into many zones, which contain sounds triggered when the hand moves into their boundary (e.g., the percussion mode). Several modes produce audio events that are also sensitive to the velocity of the hands and feet. (For a detailed discussion on the Sensor Chair, see MIT's Media Lab web site at http://brainop.media.mit.edu/Archive/SensorChair.html.)

Machover extended the use of hyperinstruments and other interactive interfaces to create interactive musical compositions, known as the Brain Opera. The Brain Opera is an interactive performance that evolves through collaboration with participants. Hyperinstruments, such as the Sensor Chair, Hypercello, etc., and interactive interfaces, such as “Speaking Trees”, “Harmonic Driving”, “Gesture Wall”, etc., allow participants to manipulate sound and images using gesture, touch and voice at the Brain Opera's interactive installation sites. (For a detailed discussion on the hyperinstruments and interactive installations, see MIT's Media Lab web site at www.brainop.media.mit.edu). Participant contributions are collected, then processed and re-distributed as sound and image material that is triggered by musicians playing the hyperinstruments at the Brain Opera performance. Additionally, interfaces were also designed which allow participants to contribute sounds and images and participate in Brain Opera performances over the Internet.

In the visual arts area, artist Camille Utterback combines cameras, projectors and software to create interactive artwork that responds to the presence of people in a room. (http://fargo.itp.tsoa.nyu.edu/˜camille/index.html) One example of Utterback's artwork is an interactive installation called “Text Rain”. In the Text Rain installation, participants stand or move in front or a large projection screen. On the screen, they see a mirrored video projection of themselves in black and white, combined with a color animation of falling text. Like rain or snow, the text appears to land on the participants' heads and arms. The text responds to the participants motions and can be caught, lifted and then let fall again. The falling text will land on anything darker than a certain threshold, and fall whenever that obstacle is removed.

With the recent drop in traditional CRT (cathode ray tube) monitor prices and the rise of sophisticated flat-panel displays, there is an increased market demand for interactive installations that display dynamic art as well as deliver news, movies and World Wide Web (www) content.

### SUMMARY OF THE INVENTION

It is, therefore, an objective of the present invention to provide a system and method for processing an image.

It is another object of the present invention to provide a system and method which allows a user to display an image and to define “active rules” as to how the image will be transformed based on human interaction and the environment.

It is a further object of the present invention to provide an interactive video installation.

In accordance with these objectives, the invention provides a real-time interactive video system. The inputs to the system are given through an array of cameras, sensors and microphones. The inputs are generated by human (or pet) presence and involvement. A set of software modules is invoked based on a “rule” framework created by the user, e.g., artist or designer, of the interactive system. The “rules” define which set of inputs are connected to certain portions, i.e., impressible regions, of an image on a display of the system or connected to certain portions on a mosaiced display.

The software modules include, among other things, vision modules for segmenting human (or pet) motion and faces, finding overall color on a person's clothes, finding overall color in an exhibit room and finding overall texture from the images acquired through the input cameras coupled to the interactive system. The inventive system allows the user to build a set of “active rules” as to how the impressible regions of the displayed images can change based on motion, color, and/or texture of a “visitor” interacting with the system.

According to one aspect of the present invention, an interactive imaging system is provided. The system includes a display for displaying an initial image and a processing system for transforming the initial image. The processing system segments the initial image into a plurality of impressible regions, processes at least one input signal and associates at least one input signal to at least one impressible region whereby the at least one input signal will transform the impressible region to a different state. The at least one input signal may be a visitor's facial expression, color of the visitor's clothes, etc. and can be generated from any combination of cameras, pressure-sensitive tactile sensors, microphones and scent detectors. The display can be either a single liquid crystal display (LCD) or a plurality of LCDs arranged in a mosaic form. The system may further include an audio player for playing a digital audio file responsive to the at least one input signal.

According to another aspect of the present invention, a method for processing an image is provided. The method includes the steps of displaying an initial image on a display means; segmenting the initial image into a plurality of impressible regions; processing at least one input signal; and associating the at least one input signal to at least one of the plurality of impressible regions whereby the at least one input signal will transform the impressible region to a different state. Additionally, the method provides for recording the transformation of the initial image over a period of time; and playing the recorded transformation on the display means.

### BREIF DESCRIPTION OF THE DRAWINGS

The above and other objects, features and advantages of the present invention will become more apparent from the following detailed description when taken in conjunction with the accompanying drawings in which:

FIG. 1 is a prior art human-machine interactive system utilized as a musical instrument;

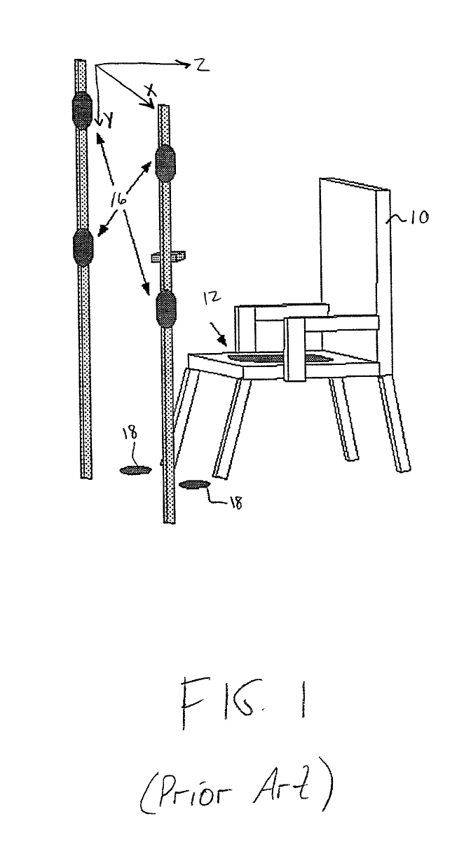

FIG. 2 is a block diagram illustrating the components of an interactive imaging system in accordance with the present invention;

FIG. 3 is a schematic diagram of the interactive imaging system according to a first embodiment of the present invention;

FIG. 4 is a flow chart illustrating the method for processing an image in the interactive imaging system of the present invention;

FIGS. 5A to 5C are several views of a display of the interactive imaging system of the present invention;

FIGS. 6A and 6B are schematic diagrams of the interactive imaging system according to a second embodiment of the present invention; and

FIGS. 7A and 7B are schematic diagrams of the interactive imaging system according to a third embodiment of the present invention.

### DETAILED DESCRIPTION OF THE INVENTION

Preferred embodiments of the present invention will be described herein below with reference to the accompanying drawings. In the following description, well-known functions or constructions are not described in detail since they would obscure the invention in unnecessary detail.

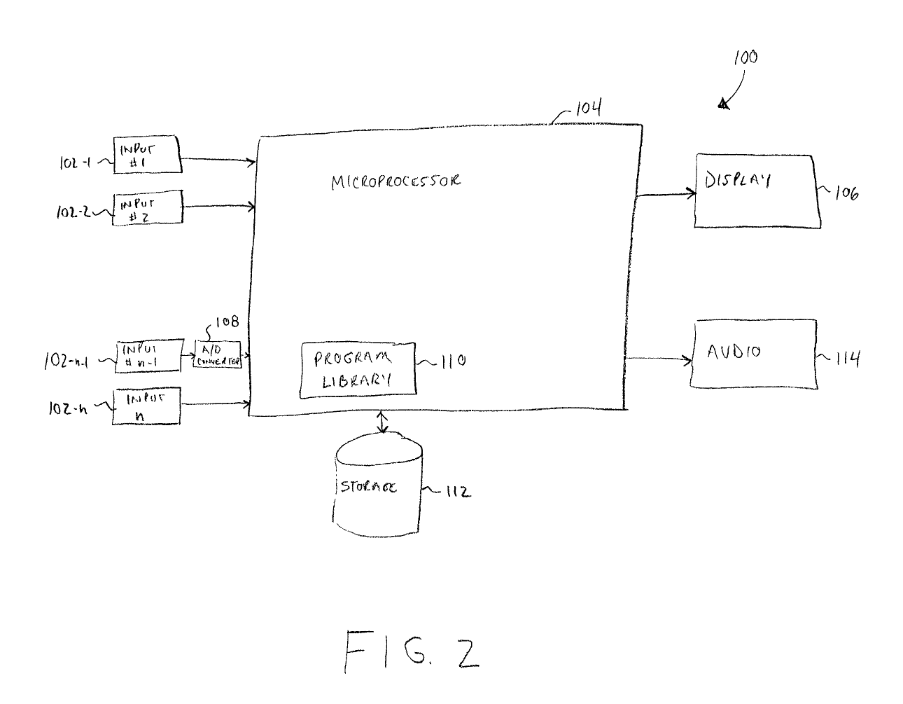

FIG. 2 is a block diagram illustrating the basic components of an interactive imaging system in accordance with the present invention. The system 100 includes a plurality of input sensors 102-l through 102-n, a microprocessor 104, and a display 106. Each input sensor can be any one or combination of the following exemplary sensors: a camera, a pressure-sensitive tactile sensor, a microphone and a scent detector. It is to be understood that the input sensors output a digital signal to be received by the microprocessor for further processing. Additionally, it is to be understood that if the input sensors are analog devices, the system will further include an analog-to-digital converter 108 to converter the input signal into proper form to be processed by the microprocessor 104.

The microprocessor 104 includes a program library 110 which contains various conventional software modules for processing the input signals from the input sensors. For example, for use in conjunction with an input signal from a video camera, a module can be invoked to segment and identified all objects in a given image. Another module may be used to determine the overall color of clothes on a person or the overall color or texture of a room. Additionally, modules may perform facial expression recognition, age recognition or ethnicity recognition of a person who enters the field of vision of one of the cameras of the system. Moreover, a module will be provided for allowing a user to associate the various input signals to various portions of an image being displayed thereby creating a set of “active rules” to transform the image.

The display 106 of the system will initially display an image which will change over time based on the input signals. The display 106 may be any conventional display, for example a CRT (cathode ray tube) monitor, a liquid crystal display (LCD), flat-panel plasma devices, etc. The initial image displayed can be acquired from an input sensor, i.e. a camera, or can be retrieved from a memory or storage device 112. The storage device 112 can also record over time the transformation of images to be played back at a later time.

The system 100 may optionally further include an audio output device 114, such as a speaker. The audio output device will play digital audio files stored in memory 112 responsive to the input signals of the input sensors.

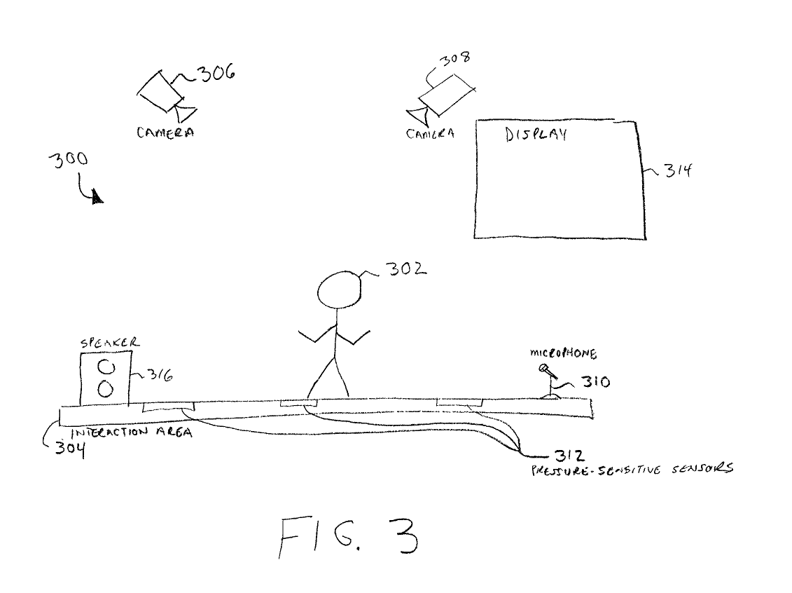

With reference to FIGS. 3 through 5, a preferred embodiment and method thereof of the interactive imaging system will be discussed.

As shown in FIG. 3, the interactive imaging system of the present invention is embodied as an interactive art exhibit 300. In this embodiment, a “visitor” 302 enters an interaction area 304 where the visitor 302 will influence the exhibit 300. The interaction area 304 is a portion of the exhibit 300 where the visitor's motion, gestures, colors, etc. can be sensed by the input sensors 306, 308, 310, 312. The exemplary input sensors for this embodiment include cameras 306, 308 for capturing images of the visitor, a microphone 310 for detecting the sounds of the visitor and others in proximity to the exhibit, and pressure-sensitive floor sensors 312 for determining the visitor's location in the exhibit. Input signals from the input sensors are sent to a microprocessor, which is hidden in the exhibit, for processing and manipulation by the software modules to generate audio/video outputs from the microprocessor that change or influence the displayed image as described further below. The outputs of the system, i.e., the display 314 and speaker 316, can be experienced by the visitor 302 in the interaction area 304 or by others just outside the interaction area 302.

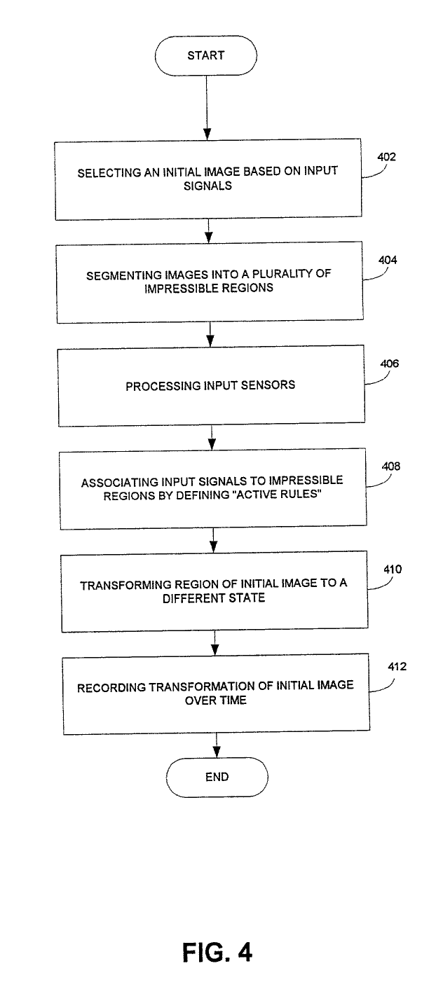

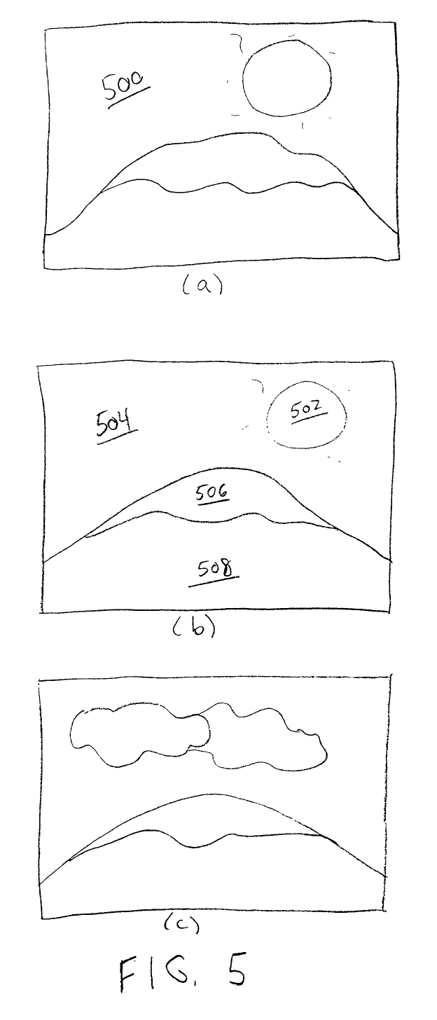

With reference to FIGS. 4 and 5, the operation of the interactive system of FIG. 3 will be discussed. Unless otherwise noted, the steps are performed by the system microprocessor that interfaces with the sensors and output devices shown in FIG. 3. When a visitor 302 enters the interaction area 304, an initial image 500 is displayed on display 314 in step 402 as shown in FIG. 5(a). It is to be understood that the initial image displayed can either be an image previously stored and then retrieved from memory of the system microprocessor, can be an image acquired from cameras 306 and 308 when the visitor enters the interaction area or can be an image acquired from a camera at a distant location, e.g., via a web cam from Times Square in New York. The rules programmed by the user will determine which image is to be displayed based on any one of the input signals. In this example, the image 500 shown in FIG. 5(a) is an image of a sunrise over the top of Mount Fuji.

In step 404, the initial image is segmented into impressible regions, i.e., areas that can be affected by the visitor. The image segmentation process is a process where each object in the image is found and isolated from the rest of the scene. For the purposes of this invention, a region is a connected set of pixels, that is, a set in which all the pixels are adjacent or touching. The image segmentation process can be performed by any conventional technique such as the region approach method, where each pixel is assigned to a particular object or region (e.g., thresholding); the boundary approach method, where only the boundaries that exist between the regions are located (gradient-based segmentation); and the edge approach method, where edge pixels are identified and then linked together to form the required boundaries. As shown in FIG. 5(b), the initial image is segmented with the microprocessor into four (4) regions: (1) the sun 502; (2) a clear sky 504; (3) a snowcap of Mount Fuji 506; and (4) a green forest region of Mount Fuji 508.

Although the initial image can be segmented into multiple impressible regions, these regions can also be classified into one of several recognizable categories. For example, an image region could be classified into human face, pet, flower, building, sofa, etc. Also, a number of regions or the entire image could be classified as indoors or outdoors image. In the video domain, the segmentation and the classification is based on content based video analysis and indexing technology (e.g. see U.S. patent application Ser. No. 09/442,960 entitled “Method and Apparatus for Audio/Data/Visual Information Selection”, filed by Nevenka Dimitrova, Thomas McGee, Herman Elenbaas, Lalitha Agnihotri, Radu Jasinschi, Serhan Dagtas, Aaron Mendelsohn, on Nov. 18, 1999.) For example, the video could be analyzed as a sequence of images and could result in a segmented “object” such as a “walking person” or a “standing person”, or a high level classification such as fast motion. In terms of input from an outdoors camera, the input can be classified into day, night, windy weather, storm, traffic jam, crowd, explosion, etc. In the audio domain, there are seven audio categories that include silence, single speaker speech, music, environmental noise, multiple speakers' speech, simultaneous speech and music, and speech and noise. In addition, the system can recognize the voice identity of an individual. (see reference: D. Li, I. K. Sethi, N. Dimitrova, and T. McGee, Classification of General Audio Data for Content-Based Retrieval, Pattern Recognition Letters, vol. 22, pp. 533-544, 2001.)

In step 406, microprocessor of the system 300 processes the input signals from the sensors inputs. For example, the microprocessor receives an input signal as a digital image from cameras 306, 308. The processor then processes the image using conventional techniques known in the art to do any one or combinations of more than one of: identify and track human (or pet) motion, to determine the overall color of the visitor's clothes, to determine the overall color of the exhibit, to recognize the facial expression of the visitor, to determine the visitor's age and ethnicity, etc. The above-mentioned techniques are described in detail in the following documents all of which are incorporated by reference: “Tracking Faces” by McKenna and Gong, Proceedings of the Second International Conference on Automatic Face and Gesture Recognition, Killington, Vt., Oct. 14-16, 1996, pp. 271-276; “Mixture of Experts for Classification of Gender, Ethnic Origin and Pose of Human Faces” by Gutta, Huang, Phillips and Wechsler, IEEE Transactions on Neural Networks, vol. 11, no. 4, pp. 948-960 (July 2000); and “Hand Gesture Recognition Using Ensembles of Radial Basis Function (RBF) Networks and Decision Trees” by Gutta, Imam and Wechsler, International Journal of Pattern Recognition and Artifical Intelligence, vol. 11, no. 6, pp. 845-872 (1997).

Additionally, the processor may receive an audio input signal from the microphone 318 and subsequently analyze the signal to determine the mood of the visitor. For example, if the microphone 318 picks up a fast, high pitch voice, the processor will determine the visitor is stressed or angry, and conversely, if the microphone 318 picks up a slow, low pitch voice, the microprocessor will determine the visitor is calm. Moreover, the mood or state of the visitor can be analyzed based on the visitor's motion throughout the exhibit as captured by the cameras 306,308, i.e. fast motion being stressed and slow motion being calm.

It is to be understood that the input signals can also be segmented and classified. It is further to be understood that the input signals can be stored in the storage device before being processed to be used at a later time. Additionally, the processed input signals, being segmented and classified, can also be stored in the storage means for future use in the system.

In step 408, a user, i.e., the artist or designer, associates (via programming “active rules” in the microprocessor) the input signals to the regions 502, 504, 506, 508 of the image. During the system design and setup, there are multiple categories of active rules that can be set in the system. Each rule will cause an input signal or signals to “trigger” one or several events or transformations. Simple triggers that appear as rules can be expressed as:

if A then B

For example, if the dominant color of an input image signal is “red” then change the displayed image on the display to a new image selected randomly from the database.

The triggers can be uni-modal and cross-modal. In the uni-modal case both left and right hands sides of the rule effect the same modality: e.g. audio input affects the audio output of the system. Cross-modal triggers are used for changing a signal in a different modality: e.g. a visual input signal is used to change the smell in the room.

Complex triggers that can have a complex logical predicate on the left hand side of the rule and can have the form:

if A and C then B

For example, if the dominant color of an input image signal is “red” and an input smell=lemon then change the displayed image on the display to a new image selected randomly from the database. Also the right hand side of the rule can have a complex form and modify multiple signals at the same time. Additionally, the modification of the signals can also be set with a temporal delay.

It is also contemplated that the rule will have a cascading effect, that is, the output signal can change the environment (say the output could be the ambient light) and this can have an interaction in turn with the colors that people are wearing and there could be a cascading effect on the activated triggers.

Below will be described several examples of how input signals will transform the outputs of the system in relation to system shown in FIG. 3. For example, the results of the facial expression analysis, via the processing software, may be associated with region 504; if it is determined that the visitor is happy, the region 504 will turn blue to represent a bright sunny day in step 410. On the contrary, if the gesture of the visitor indicates he or she is angry (as determined by an image recognition module that determines facial expression), the region 504 will turn gray and region 502 will be removed and replaced with an image of clouds as shown in FIG. 5(c).

In another example, the results of a speech analysis, where the voice of the visitor is captured by microphone 318, may be associated to a specific region or the boundaries between regions, e.g., if the visitor's is determined to be stressed (from the analysis of a fast high voice), the boundaries connecting the various regions may become jagged. Additionally, a stressed condition of the visitor may trigger, by the “rules” programmed by the designer, the playing of a soothing audio file.

In yet another example, the images captured by the cameras 306, 308 will be processed (for example, by identifying the person and generating a color histogram for the sub-region of the image occupied by the person) to determine the overall color of the visitor's clothes, which in turn can be associated to a region which will mirror the color determined.

It is contemplated by the present invention that various input signals can be combined to effect a region of the displayed image. For example, if it is determined that the visitor is happy and a scent detector detects perfume, region 504 will turn purple. It is additionally contemplated that multiple input signals can have multiple effects on an image, for example, if it is determined that a visitor is happy and is wearing the color purple, the sun in region 502 is moved to represent a sunset and an audio file representing a saxophone is played.

In step 412, the transformation of images may be recorded and stored in memory. The stored images can be played back at a later time or can be used as the initial image with the process returning to step 402.

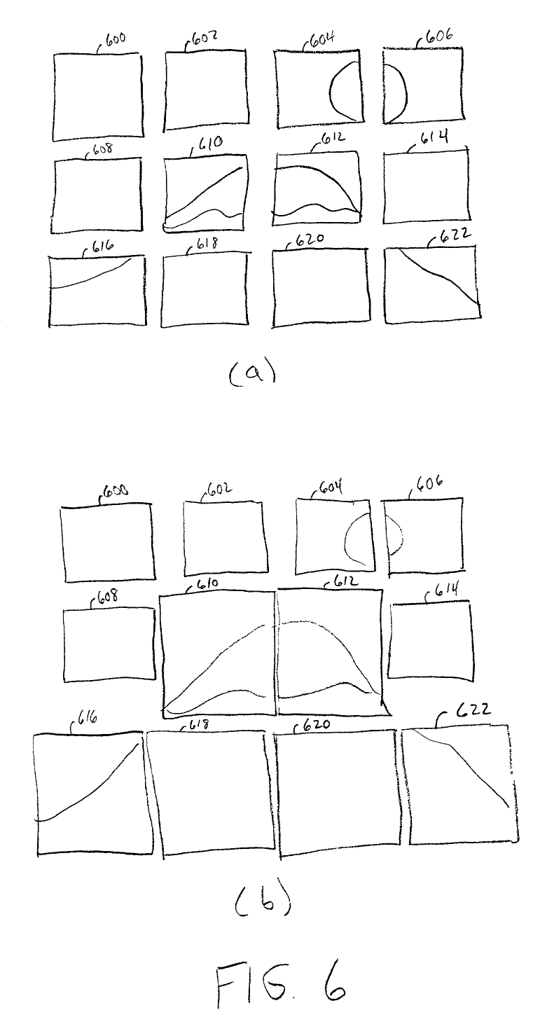

FIG. 6 illustrates a display of a second embodiment of the present invention. In this embodiment, all the components of FIG. 3 are similar and have the same functionality except for the display. As shown in FIG. 6(a), the display is constructed from several liquid crystal displays (LCDs) 600-622 in mosaic form. Here, the initial image is displayed among all the LCDs 600-622 as if all the LCDs were one large display. It is also contemplated that each LCD 600-622 individually displays a different initial image.

A modification to the second embodiment includes each of the LCDs 600-622 having separate supports or mounts having adjustable orientation. An actuator, such as stepper motors or like electromechanical device such as a piezo-electric driver, can orientate the LCDs in response to an input signal from the input sensors. As shown in FIG. 6(b), LCDs 610, 612, 616, 618, 620 and 622 have been driven forward in response to an input to the system to create different depths of the initial image. Here, the LCDs have been driven to have Mount Fuji appear closer and the sun appear to be off in the distance.

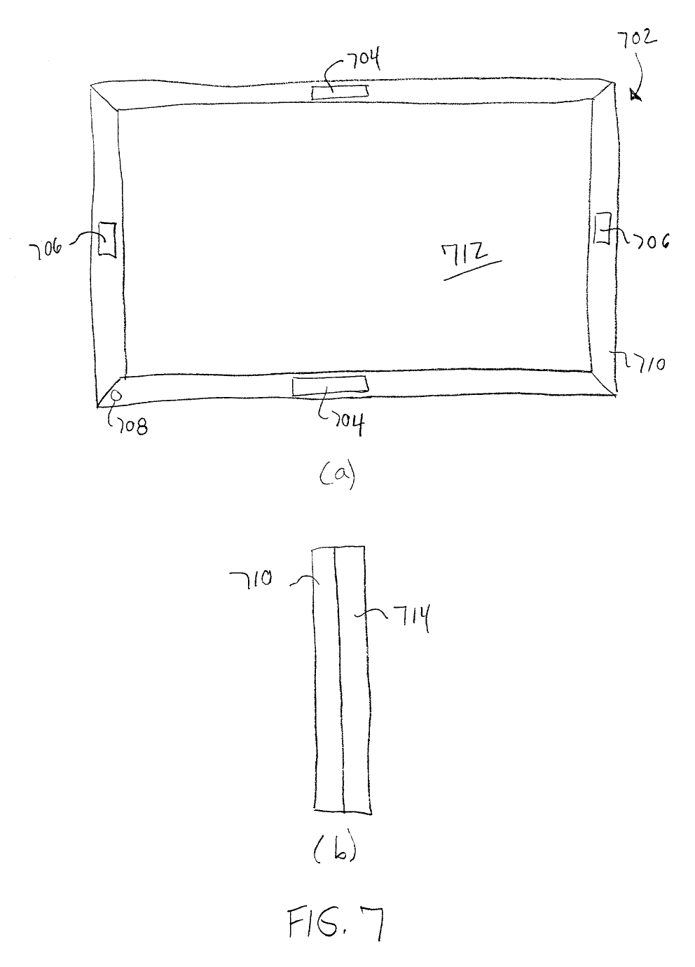

A third embodiment of the interactive imaging system is shown in FIG. 7. Here, all components of the system are mounted on or within a single flat-panel device 702. As shown in FIG. 7, the input sensors (cameras 704 and microphone 708) and the audio output devices (speakers 706) are mounted in the frame 710 of display 712. The processor 714 required for the system can be mounted on the rear surface of the device as shown in FIG. 7(b) or can be a stand-alone processor contained in a personal computer coupled to the device. In either case, if an Internet connection is coupled to the device 702, the display 712 can be utilized to play news, movies and web content.

It is also to be contemplated by the present invention that the various inputs actually created the initial image instead of just influencing it. For example, each of the various inputs to the system create an individual impressible region, that is, the results of the speech recognition analysis could determined a background or background color (stressed equals red, calm equals blue), an image captured by a camera could be placed over the background, and the visitor's motion could determine the smoothness of the boundaries between the impressible region.

It is also contemplated that the system of the present invention has artificial intelligence to learn a specific pattern of a frequent visitor. Once a person is recognized, the system should remember the facial features of the visitor and store them in a database. One of the “triggers”, or rules, could be that the next time the same person is recognized, the system retrieves the image/video from the previous visit in order to show the visitor that it recognized him/her. Also, if the system remembers the actions from the triggers during the last visit(s) then the system will select the next rule. This means that the system is capable of executing “meta-rules”. If the system recognizes its previous behavior then it invokes the “rule-changing” triggers so that it appears intelligent. In addition, the meta-rule can specify that after certain number of visits the colors and the complete style of displayed images or signals is remembered and evolved as well.

While the invention has been shown and described with reference to certain preferred embodiments thereof, it will be understood by those skilled in the art that various changes in form and detail may be made therein without departing from the spirit and scope of the invention as defined by the appended claims.

What is claimed is:

1. An interactive imaging system comprising:
a display for displaying a displayed image in initial and transformed states; and
a processing system that segments the displayed image into a plurality of impressible regions; operates on at least one input signal by associating at least one input signal to at least one impressible region, whereby the at least one input signal transforms the impressible region to a different state, thereby transforming the state of the displayed image.

2. The system as in claim 1, wherein said display is a single liquid crystal display (LCD).

3. The system as in claim 1, wherein said display is a plurality of liquid crystal displays (LCDs) in mosaic form.

4. The system as in claim 3, wherein each of the plurality of LCDs is mounted on adjustable, motorized supports, said support being responsive to said at least one input signal.

5. The system as in claim 3, wherein each of the plurality of LCDs of said display displays a different displayed image.

6. The system as in claim 3, wherein each of the plurality of impressible regions is displayed on an individual LCD of the plurality of LCDs.

7. The system as in claim 1, wherein said at least one input signal is generated from a sensor chosen from the group consisting of a camera, a pressure-sensitive tactile sensor, a microphone and a scent detector.

8. The system as in claim 1, further comprising an audio system for playing a digital audio file responsive to the at least one input signal.

9. The system as in claim 1, further comprising a storage means for storing a plurality of images to be used as the initial displayed image and for storing the transformation of the displayed image for a period of time.

10. The system as in claim 1, wherein the processing system further comprises a program library including one or more imaging vision modules for at least one selected from the group of segmenting human motion and faces, finding overall color of a user's clothes, determining overall color in a room and determining the texture of an object, the one or more imaging vision modules operating on an input image signal to determine the transformation of an impressible region to a different state.

11. The system as in claim 1, wherein said at least one input signal is generated by the presence of a person in the proximity of the displayed image and said processing system identifies at least one characteristic of the at least one input signal and associates the at least one characteristic of the at least one input signal to the at least one impressible region, the at least one characteristic transforming the state of the at least one impressible region.

12. The system as in claim 1, wherein said at least one input signal is an image and said processing system identifies at least one expression of a person and transforms the displayed image based on the identified expression.

13. The system as in claim 1, wherein said at least one input signal is an image and said processing system identifies at least one color of a person's clothes and transforms the displayed image based on the identified color.

14. The system as in claim 1, wherein said at least one input signal is a voice and said processing system identified a tone of the voice and operates on the displayed image as a function of the tone.

15. A method for processing an image, the method comprising the steps of:
displaying an initial image on a display means;
segmenting the initial image into a plurality of impressible regions;
processing at least one input signal; and
associating the at least one input signal to at least one of the plurality of impressible regions and transforming each of the at least one impressible region to a different state based on the associated at least one input signal.

16. The method as in claim 15, further comprising the step of acquiring the initial image using a camera.

17. The method as in claim 15, further comprising the step storing a plurality of images to be used as the initial image.

18. The method as in claim 15, wherein said display means is a single liquid crystal display (LCD).

19. The method as in claim 15, wherein said display means is a plurality of liquid crystal displays (LCDs) in mosaic form.

20. The method as in claim 19, wherein the step of displaying the initial image includes displaying a different initial image on each of the plurality of LCDs of said display means.

21. The method as in claim 19, wherein the step of segmenting the initial image into a plurality of impressible regions includes displaying each of the plurality of impressible regions on individual LCDs of the plurality of LCDs.

22. The method as in claim 15, wherein said at least one input signal is generated from a sensor chosen from the group consisting of a camera, a pressure-sensitive tactile sensor, a microphone and a scent detector.

23. The method as in claim 15, further comprising the step of playing a digital audio file through an audio means responsive to the at least one input signal.

24. The method as in claim 15, further comprising the steps of:
recording the transformation of the initial image over a period of time; and
playing the recorded transformation on the display means.

25. The method as in claim 15, wherein the step of processing the at least one input signal further includes the steps of:
segmenting human motion from an acquired image acquired by the at least one input sensor;
determining overall color of clothes of the human in the acquired image;
determining overall color of the acquired image; and
determining texture of the human in the acquired image.

26. The method as in claim 15, wherein each of the at least one input signal is associated to at least one of the plurality of impressible regions based on a type of each of the at least one input signal.

27. The method as in claim 26, wherein a module is invoked based on the type of each of the at least one input signal, the module associating the respective input signal to at least one of the plurality of impressible regions.

28. The method as in claim 15, wherein the transformation of the at least one impressible region to a different state is based on a type of the associated at least one input signal.

29. The method as in claim 28, wherein a module is invoked based on the type of each of the at least one input signal, the invoked module for each input transforming the associated at least one impressible region for the input.

30. The method as in claim 15, wherein the step of associating the at least one input signal to at least one of the plurality of impressible regions is defined by a plurality of active rules which triggers the transform based on the at least one input signal.

31. The method as in claim 30, wherein at least one of the plurality of active rules is uni-modal.

32. The method as in claim 30, wherein at least one of the plurality of active rules is cross-modal.
